(19) United States
(12) Patent Application Publication
(10) Pub. No.: US 2005/0181719 A1
(43) Pub. Date: Aug. 18, 2005

(54) Poultry conveying apparatus

(76) Inventors: Ian Ramsey Taylor, Waubaushene (CA); Christopher Mark Tyrrell, Bungay (GB); Barry William Landymore, Diss (GB); Robert William Wills, Parva (GB)

Correspondence Address: BARNES & THORNBURG, P.O. BOX 2786, CHICAGO, IL, 60690-2786, US

(21) Appl. No.: 10/991,067

(22) Filed: Nov. 17, 2004

(30) Foreign Application Priority Data
Feb. 13, 2004 (GB) UK 0403239.7

(51) Int. Cl. A22B 3/00

(52) U.S. Cl. 452/66

(57) ABSTRACT

Poultry conveying apparatus is used in gas stunning apparatus for the gas stunning of poultry. The conveying apparatus comprises a conveyor for transporting poultry through a gas or gases in a chamber of the gas stunning apparatus. The gas or gases are effective to stun the poultry. As the poultry is conveyed through the chamber poultry restraining elements engage the poultry to prevent or inhibit movement of the birds relative to the conveyor. This restrains the birds as they react to the gas or gases in the chamber and can thus prevent or reduce damage to the birds, and can ensure that there is little or no movement of the birds relative to the conveyor.

### FIELD OF THE INVENTION

This invention relates to poultry conveying apparatus for apparatus for the gas stunning of poultry, gas stunning apparatus having such poultry conveying apparatus and to a method of stunning poultry. The term stunning is used herein to mean loss of mobility or motor function on the part of the poultry, e.g. resulting from anoxia, loss of consciousness or death.

### BACKGROUND TO THE INVENTION

Gas stunning is intended to overcome some or all of the problems of previous methods of stunning poultry, involving passing an electric current through each bird. Gas stunning methods involve exposing the birds to a gas or mixture of gases effective to stun or kill the birds. An example of gas stunning apparatus is shown in the present applicant's European Patent No. EP 0664957. This apparatus receives the poultry in a number of containers which are lowered into a chamber for accommodating a heavier than air gas or gases. The containers are then conveyed through the chamber and lifted out of the chamber top.

Although being less prone to the type of damage associated with electrical stunning techniques, poultry passing through a gas stunning apparatus can move in reaction to the gas mixture and such movement can damage a bird as it passes through the chamber.

### SUMMARY OF THE INVENTION

According to a first aspect of the invention, there is provided poultry conveying apparatus for gas stunning apparatus for the gas stunning of poultry, the poultry conveying apparatus comprising conveying means for transporting the poultry through a gas or gases in a chamber with the gas stunning apparatus, said gas or gases being effective to stun the poultry; and poultry restraining elements operable to engage poultry to prevent or inhibit movement of the poultry relative to the conveying means as the poultry is transported through at least part of the chamber, thereby to restrain the birds as they react to the gas or gases in the chamber.

In known types of gas stunning apparatus, the birds are transported through the chamber on a conveyor. In some of these types of apparatus, the birds are also confined in open topped drawers to prevent them from escaping. In either case the restraining elements of the present invention, can restrain poultry passing through the chamber and can prevent excessive movement of each bird. The elements can therefore prevent or reduce damage to the birds as they react to the gas or gases in the chamber.

Preferably the elements constitute an array of elements which extend as far as an infeed opening through which poultry enters the chamber.

The elements of such an array can thus also restrain poultry entering the chamber, to prevent the birds from retreating away from the infeed opening, for example if the gas or mixture of gases in the chamber is such as to be perceptible to the birds.

Preferably the elements comprise an array of flexible, preferably resilient, protuberances.

Preferably the protuberances, in use, extend into the path of the poultry through the chamber. The protuberances may comprise resilient fingers preferably arranged in a regular array.

Preferably the protuberances comprise a series of flaps.

There are a number of different ways in which the protuberances may be arranged. For example, they may be mounted on a side conveyor or pair of side opposed conveyors and thus project horizontally. Alternatively, the protuberances may extend upwardly beneath the poultry to pin the latter against, for example, an overhead plate.

Each protuberance may comprise a resilient support member covered by a respective flexible cover. Such a cover may comprise a flap. There may also be provided a plurality of resilient members, each comprising a resilient finger.

This type of protuberance is particularly suitable where the protuberances are mounted on a side conveyor.

Preferably, the apparatus includes engagement means for bringing the elements into engagement with the poultry and separation means subsequently separating the elements from the poultry to allow the latter to be removed.

The elements may be carried by the conveying means, in which case the engagement and separation means is operable to move the poultry respectively towards and away from the conveying means, thereby to cause said engagement and said separation respectively.

Preferably, however, the restraining elements are mounted in a fixed relationship to the chamber so that the conveying means moves the poultry relative to the restraining elements.

In this case, the restraining elements preferably take the form of overhead flaps each able to swing in the direction of conveyance of the poultry.

Alternatively the restraining elements are mounted on a further conveying means for moving the elements along the path of the poultry through the chamber, said further conveying means also acting as the engagement and separation means.

In this case the further conveying means may preferably be situated above said conveying means for conveying the poultry, so that the elements, in use, engage the poultry from above.

Preferably, the conveying means and further conveying means include drive means operable to drive both of said conveying means at substantially the same speed.

Thus the restraining elements move with the birds as the latter pass through the chamber.

Preferably, where the restraining elements are fingers, the further conveying means includes a belt from which the fingers project into the path of the poultry.

According to a second aspect of the invention, there is provided gas stunning apparatus for use in the gas stunning of poultry, the apparatus comprising a chamber for containing a gas or mixture of gases for stunning the poultry, conveying apparatus for conveying poultry through the chamber, feed means for supplying poultry to an infeed of the conveying apparatus and removal means for removing the poultry from an outlet in the conveying apparatus, wherein the conveying apparatus comprises poultry conveying apparatus in accordance with the first aspect of the invention.

The invention also lies in a method of stunning poultry, the method comprising the steps of:
(a) exposing the poultry to a gaseous environment effective to stun the poultry;
(b) ensuring that, when so exposed, the poultry is restrained by the restraining elements which engage the poultry to prevent or inhibit movement of the latter thereby to reduce or prevent damage to the birds as they react to the gaseous environment;
(c) subsequently removing the poultry from the gaseous environment.

Preferably, the poultry is conveyed through said environment, and the restraining elements engage the poultry prior to the commencement of said exposing step. Alternatively, the elements may come into engagement with the birds during said exposure step.

Preferably while being exposed to said gaseous environment, the poultry are conveyed from an infeed to an outlet of a chamber containing said environment.

The elements may also be conveyed with the poultry.

Preferably, the conveying step is achieved by supporting the poultry on a first conveying means. The elements may be carried by a second conveying means operating at substantially the same speed as the first conveying means.

### BRIEF DESCRIPTION OF THE DRAWINGS

The invention will now be described, by way of example only, with reference to the accompanying drawings, in which:

FIG. 1 is a sectional side view of an embodiment of gas stunning apparatus in accordance with the invention, the embodiment having restraining elements in the form of resilient fingers.

FIG. 2 is a partially cut away end view of the inlet end of the apparatus;

FIG. 3 is a simplified diagramatic side view of part of the poultry conveying apparatus (also in accordance with the present invention) forming part of the gas stunning apparatus, the figure showing a number of birds being conveyed through the apparatus in drawers;

FIG. 4 is a similar view to FIG. 3, of a modified embodiment of the poultry conveying apparatus;

FIG. 5 is another view which is similar to FIG. 3 and shows a further modified embodiment of the poultry conveying apparatus;

FIG. 6 is a similar view of a fourth embodiment of poultry conveying apparatus in accordance with the invention;

FIG. 7 is a simplified view of a fifth embodiment of poultry conveying apparatus in accordance with the invention (FIG. 7A is a cutaway view of that embodiment from one end);

FIG. 8 is a diagramatic side view, similar to FIG. 3, of a sixth embodiment of the apparatus, this embodiment having restraining elements in the form of flexible flaps;

FIG. 9 is a similar view to FIG. 3 of a seventh embodiment of poultry conveying apparatus;

FIGS. 10 and 10A are similar views to FIGS. 7 and 7A respectively, and show an eighth embodiment of poultry conveying apparatus in accordance with the invention; and

FIGS. 11-13 are similar views to that of FIG. 3, and respectively show ninth, tenth and eleventh embodiments of poultry conveying apparatus.

### DETAILED DESCRIPTION

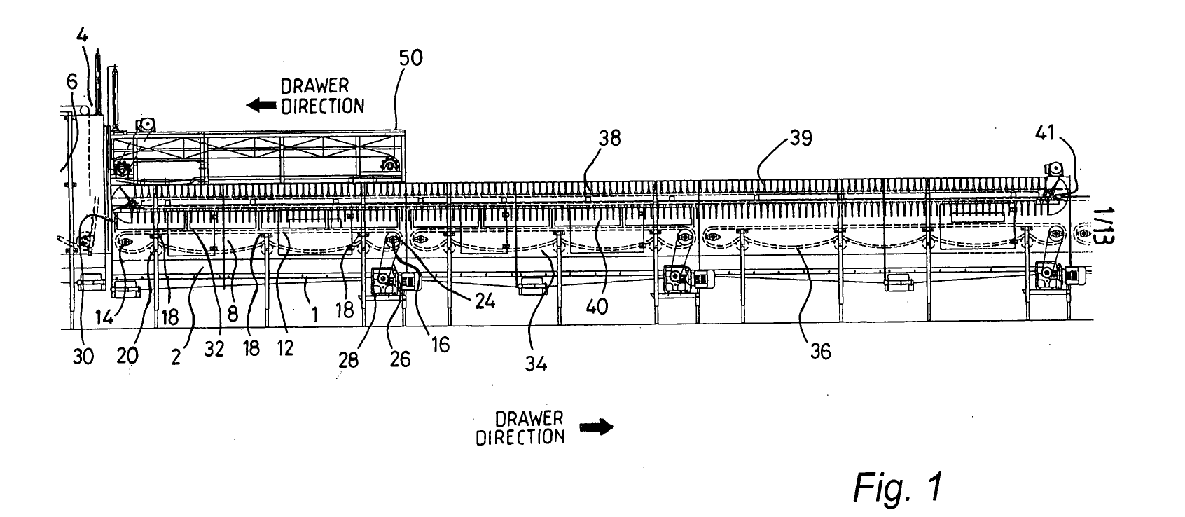

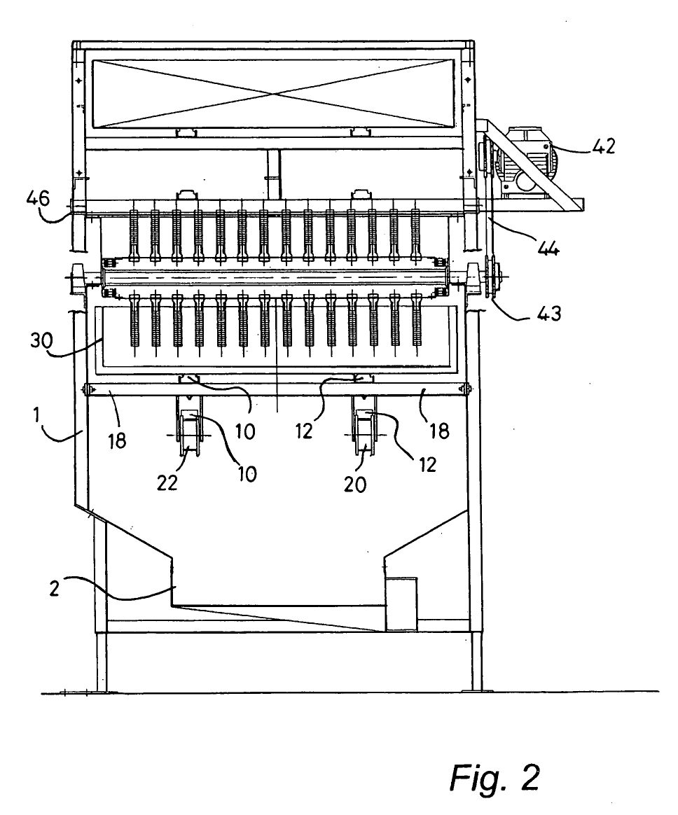

With reference to FIGS. 1 and 2, the apparatus comprises a chamber defined by a horizontally elongated tank 1 having a lower trough 2 (which facilitates cleaning of and removal of waste from the apparatus) and an infeed end 4. At the infeed end 4 of the tank is an infeed conveyer 6 which delivers containers in the form of open top drawers containing live poultry (prevented from escaping by means of a covering panel). Each drawer is moulded from a synthetic plastic material and has an apertured base and apertured side walls, and is of the type disclosed in EP 0644957. The infeed conveyor 6 presents the drawers in a serial fashion with the direction of elongation of each drawer being perpendicular to the direction of movement of the conveyer 6. The conveyor 6 receives the drawers from a level above that of the tank 1 and then lowers the drawers in sequence to the level of a first lower conveyor 8 within the tank 1. The infeed conveyer 6 is identical in form and function to the infeed conveyer of the present applicant's existing gas stunning apparatus known as the Controlled Atmosphere Stunner. The lowering of each drawer to the level of the conveyer 8 immerses the drawer and birds therein in an atmosphere of predominantly nitrogen (but little or no oxygen) contained within the chamber defined by the tank 1.

The conveyor 8 comprises a pair of parallel chains 10 and 12, each formed into a respective closed loop. The chains run over end sprocket wheels such as the sprocket wheels 14 and 16 for the chain 12 which tension the upper run of each chain. The upper runs of the chains are also supported on a series of horizontal support bars 18. The return runs of the chains run over support pulleys such as the pulleys 20 and 22.

The sprocket wheel 16 is connected via a pulley wheel 24 and belt 26 to a motor 28. A shaft (not shown) connects the pulley wheel 24 to the downstream sprocket wheel of the chain 10 so that the motor 28 acts as a drive for both the chain 10 and the chain 12, causing the drawers, such as drawers 30 and 32 resting on the upper runs of the chains 10 and 12 to be propelled from left to right as viewed in FIG. 1. The conveyor 8 is the first of a series of three such conveyors, the other conveyors being respectively referenced 34 and 36, and being operable to propel the drawers in the same direction as the conveyor 8.

It will be appreciated that the conveyors 8, 34 and 36 constitute the conveying means of the invention.

The conveyors 8, 34 and 36 extend below, and run parallel to an upper conveyor belt 38 which runs the full length of all three conveyors, and which carries an array of flexible resilient fingers, such as the finger 40, each formed of rubber. The fingers are arranged in a regular array with spacing of approximately three inches (8 cm) between each finger and any of its neighbouring fingers. In FIG. 1 the array is generally referenced 39.

The belt 38 is tensioned by a conventional arrangement of rollers and has a roller 41 (FIG. 2) connected to a motor 42 via a pulley wheel 43 and belt 44. The motor 42 is operable to drive the belt 38 at the same speed as the chains of the conveyors 8, 34 and 36.

The fingers carried by the conveyor belt 38 extend perpendicularly from the surface of the belt so that those of the fingers on the lower run of the conveyor extend down towards the bottom of the drawers underneath the fingers. The length of each finger (when not distorted) is approximately three inches less than the distance between the lower run of the upper conveyor belt 38 and the base of a drawer on one of the lower conveyors. Thus the tips on the lower run of the belt 38 are biased by the resilience of the fingers to positions which are close to the bases of the drawers situated under the fingers.

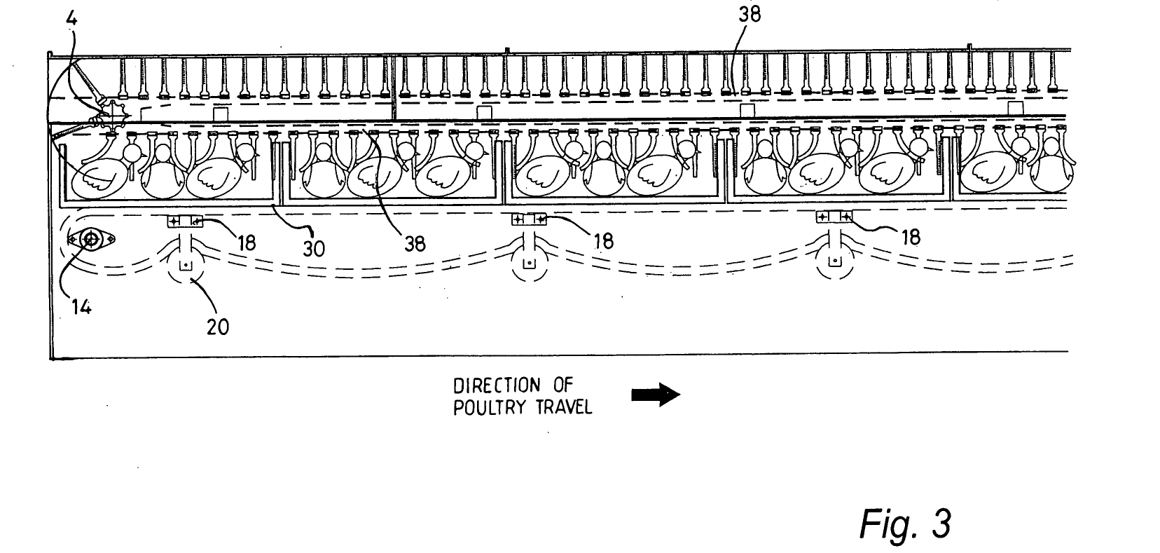

With reference to FIG. 3, it can be seen that the fingers therefore can press against any birds in the trays retaining the birds against the bottoms of the trays. The fingers are of the type conventionally used in poultry harvesting and/or poultry plucking machinery, and therefore provide a high degree of frictional interaction with the poultry which helps to stop the individual birds from moving excessively as they are conveyed through the chamber defined by the tank 1. It will also be appreciated that the upstream end of the conveyor 38 (by the infeed end 4) moves fingers from a position in which they project vertically upwards down into engagement with any poultry in the drawers being fed to the infeed end. Furthermore, as the drawers reach the downstream end of the conveyor 38, the fingers are moved away from the poultry by the travelling around the end roller 41.

The fingers on the return run of the conveyor 38 extend to just beneath an upper plate 46 which defines the top of the tank 1 in which the predominantly nitrogen atmosphere for stunning the poultry is contained.

The drawers pass from the conveyor 36 to further conveyors and the mechanism for removing the trays from the tank 1. This mechanism has not been shown or described as it is identical to the applicant's existing Controlled Atmosphere Stunner. The drawers are then passed to a hanging station at which operatives transfer the poultry from the drawers to hanging hooks. The drawers are then washed by known washing machinery (not shown) and returned to the position generally referenced 50, adjacent to the infeed conveyor 6 from which position the empty, clean containers are removed for subsequent use.

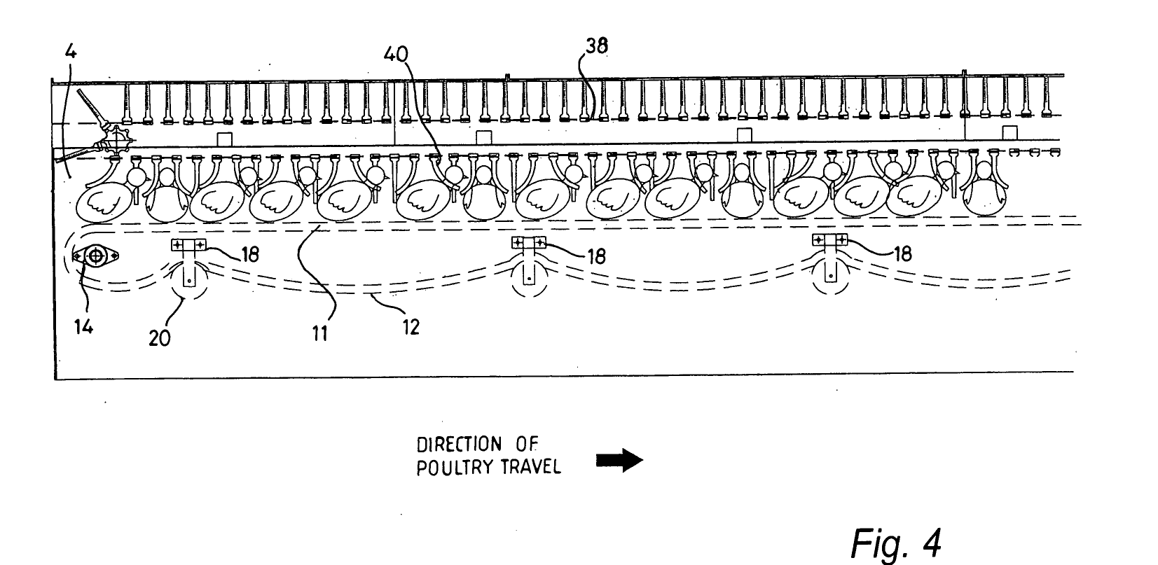

The embodiments of FIGS. 4-13 have components which are the same as, or correspond to, components of the first embodiment. In FIGS. 4-13 those components are denoted by the same reference numerals as are used in FIGS. 1-3.

In the embodiment of conveying apparatus shown in FIG. 4, the lower conveyors take the form of a single continuous conveyor belt referenced 11 on which the poultry is placed (without being contained within drawers). In this arrangement, the fingers on the upper conveyor 38 constitute primary means for restraining and containing the poultry prior to its entry to the chamber and during its subsequent passage through the chamber.

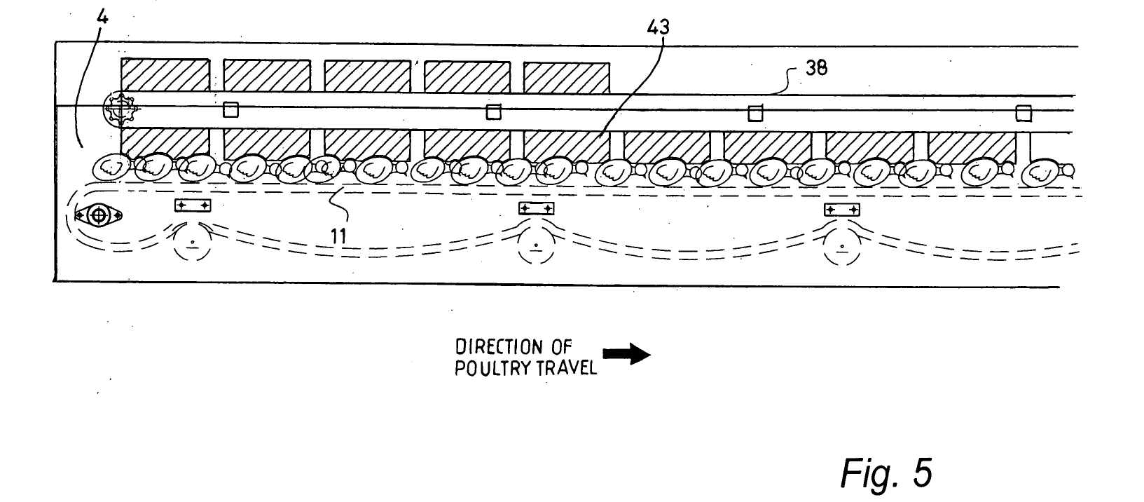

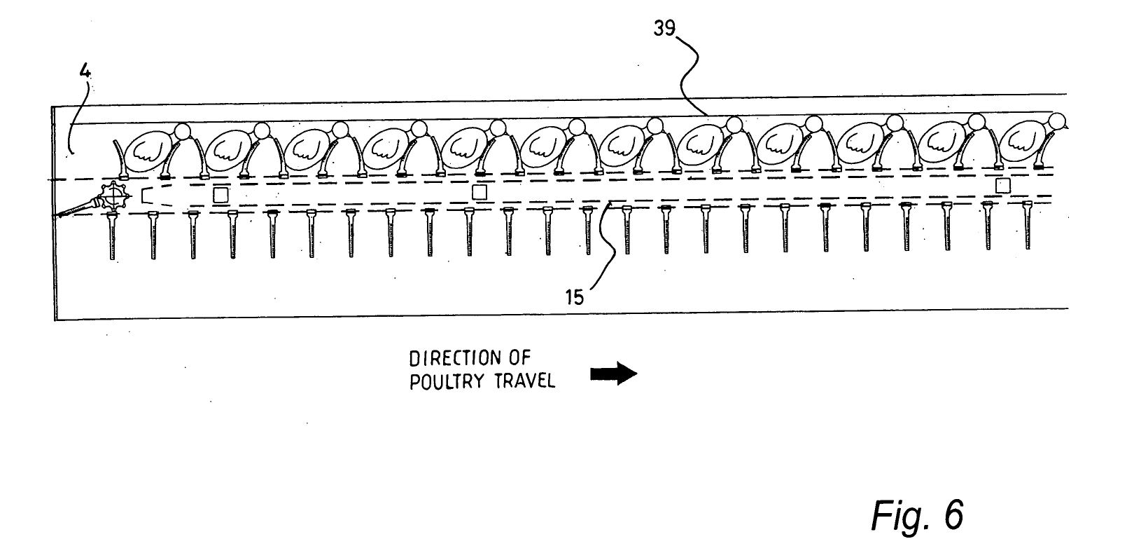

FIG. 5 shows a similar arrangement to that of FIG. 4 except the fingers have been replaced by resilient foam pads, for example pad 43, that perform the same restraining and containment function. In the embodiment shown in FIG. 6, the fingers are provided on the lower conveyor belt 15. The upper conveyor is replaced by an upper plate 39 which prevents the birds from escaping.

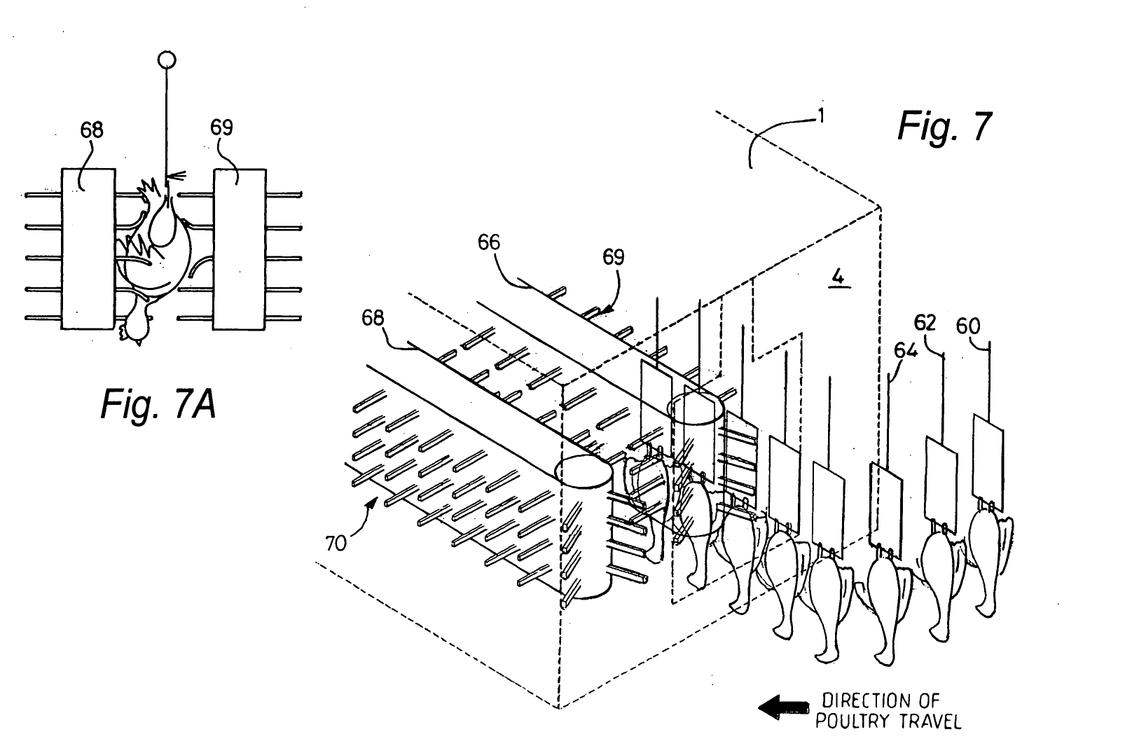

In the embodiment shown in FIG. 7, the birds are not conveyed through the chamber on an underlying support, such as a conveyor belt or tray on a pair of conveyor chains, but are instead suspended from shackles, and are restrained by means of a number of flexible horizontal fingers.

The apparatus thus includes a conveyor chain (not shown) from which a succession of shackles, such as shackles 60, 62 and 64 are suspended at regular intervals along the entire length of the chain. It will be appreciated that only some of the shackles are shown in FIG. 7. One run of the chain extends along the length of the tank 1 immediately above a pair of opposed side conveyors 66 and 68 which are disposed parallel to the chain. The birds to be slaughtered are hung from the shackles by their feet and carried into the tank 1 by the chain. The position of the chain relative to conveyors 66 and 68 is such that the birds are interposed between those conveyors as they pass through the tank 1. The conveyors 66 and 68 carry corresponding regular arrays of perpendicular flexible fingers, respectively referenced 69 and 70. The individual fingers of the arrays are flexible resilient fingers each formed from rubber. As can be seen from FIG. 7, the fingers engage the poultry passing between the conveyors 66 and 68 from opposite sides, so that each bird passing between the conveyors 66 and 68 is restrained by the fingers.

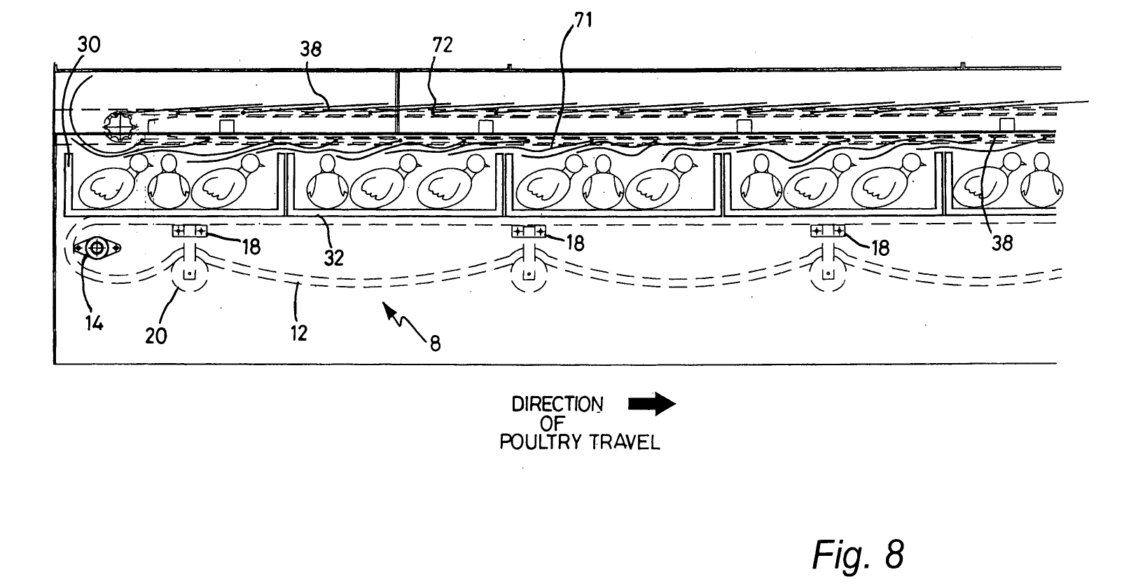

In the embodiment of apparatus shown in FIG. 8, the poultry is restrained by means of flexible rubber flaps, such as the flap 71, which are carried by the conveyor belt 38 (instead of resilient fingers). Each flap is rectangular, extends across the width of the conveyor belt 38 and is approximately 0.7 metres long and 5 mm thick. The inboard edge of each flap is formed with a part cylindrical end portion such as portion 72 which is pivotally retained on the belt 38 to enable the flap to pivot relative to the belt 38 about the axis of the portion 72.

As can be seen from the Figure, the flaps on the return run of the belt 38 lie flat on the top of the belt, with the cylindrical inboard end leading. As the flaps pass over the end of the return run, they swing down onto the birds being conveyed on the conveyor 8. Thus those flaps travel through the tank 1 with their inboard ends leading, but with the bodies of the flaps engaging the poultry so that the weight of the flaps restrains the birds.

In all other respects, the apparatus of FIG. 8 is the same as that shown in FIGS. 1-3.

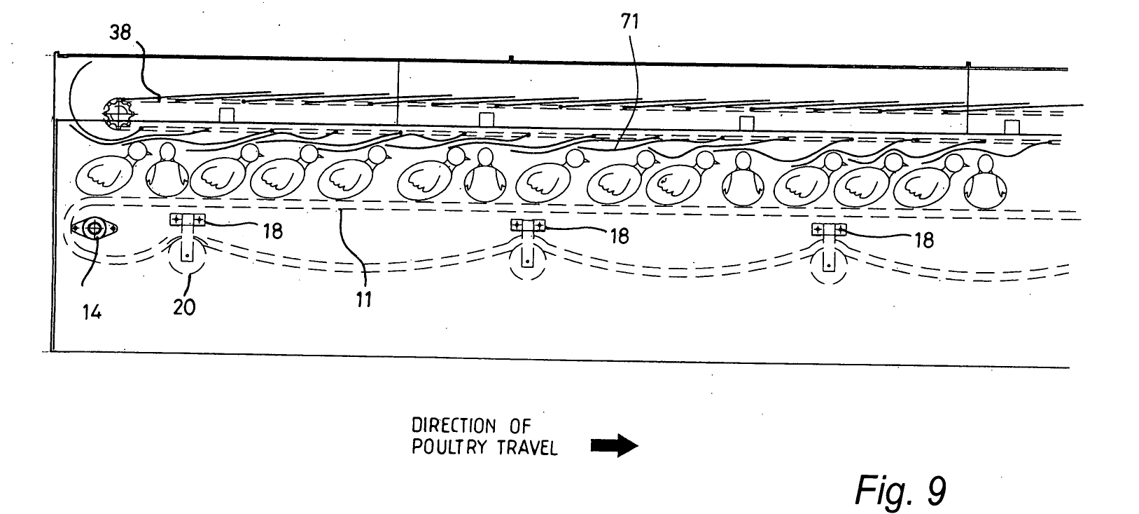

The embodiment shown in FIG. 9 is similar in many respects to that shown in FIG. 4 and corresponding components are therefore denoted by the same reference numerals as are used in FIG. 4. Thus, in the FIG. 9 embodiment the poultry is conveyed through the tank on a continuous belt 11, and the sole means of restraining the poultry and retaining it prior to its entry to the chamber is constituted by the engagement elements carried on the overhead conveyor 38. In this case, however, the elements take the form of flaps, such as flap 71, substantially identical to the flaps described in relation to the embodiment shown in FIG. 8.

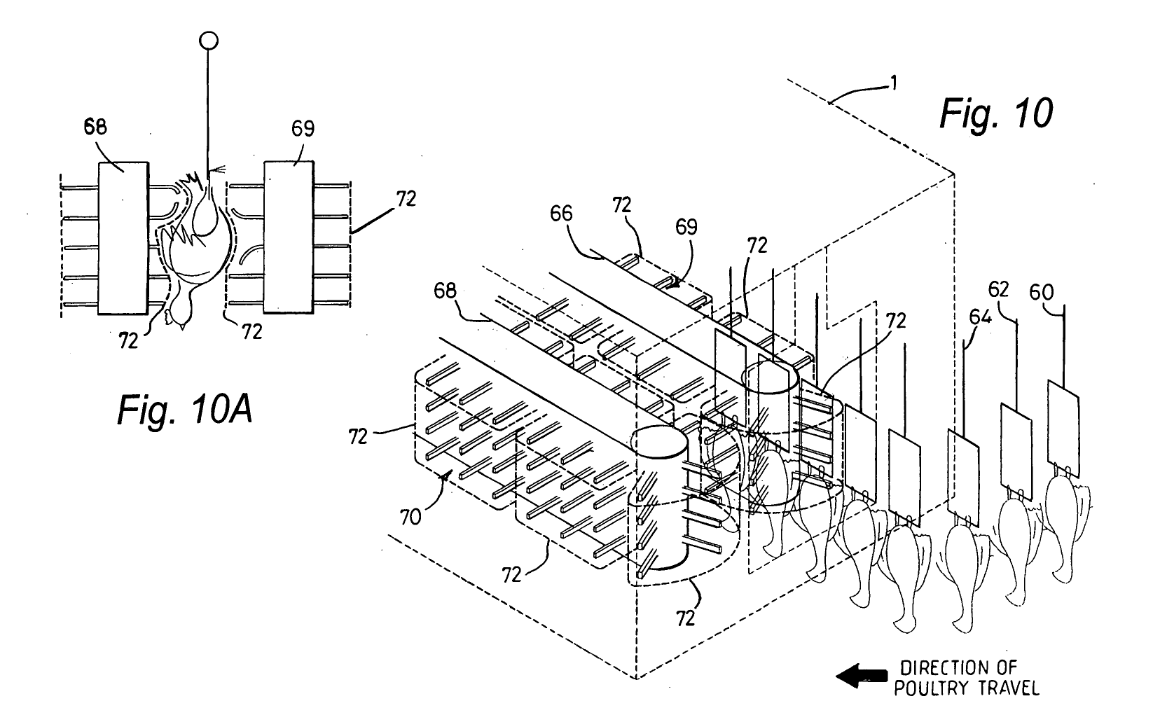

In FIGS. 10 and 10A the reference numerals of FIGS. 7 and 7A are used to denote elements which correspond to those shown in FIGS. 7 and 7A. The embodiment shown in FIGS. 10 and 10A differs from the FIGS. 7 and 7A embodiment in that, in addition to an array of fingers 69 and 70, the side conveyors 66 and 68 also carry a series of covers denoted 72. Each cover is in the form of a rubber flexible flap of similar dimensions to the flap 71. In this case, however, each flap is secured at both ends to its conveyor and extends over three columns of resilient fingers. The fingers bear against the flaps 72 to help to maintain the shape of the latter and provide resilient resistance to deformation of the flaps. As the birds are fed between the conveyors 66 and 68, they are restrained, in effect, by means of the resilient fingers acting through the flaps. Thus, as can be seen from FIG. 10A, the birds are sandwiched between the flaps on the conveyors 68 and 69, and cause resilient deformation of the fingers behind the flaps. The fingers thus exert a restraining force on the poultry through the flaps.

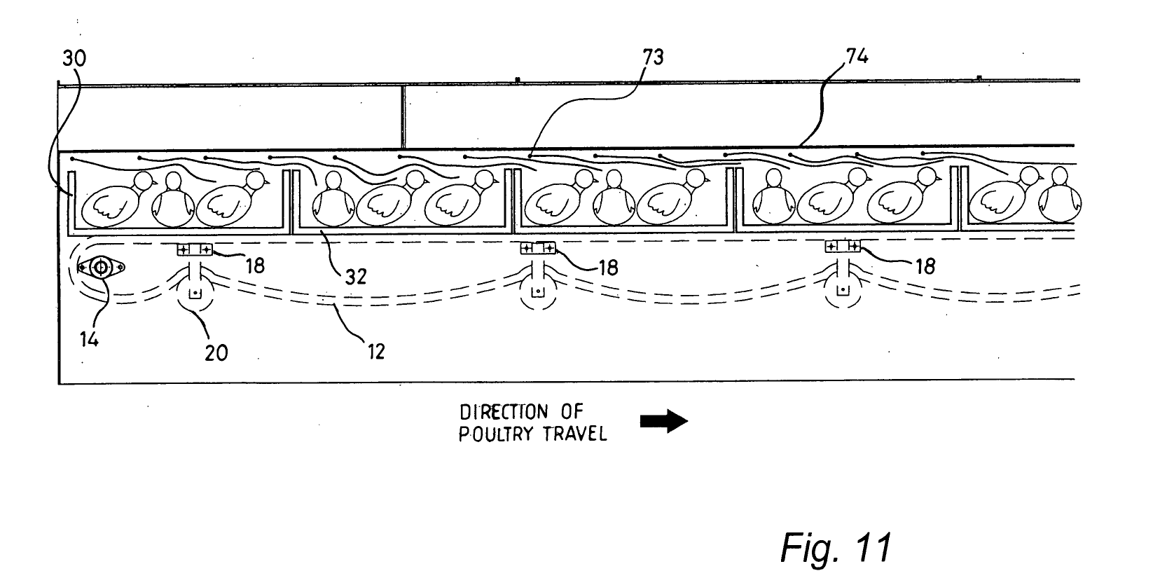

The embodiment of FIG. 11 is similar in certain respects to the embodiment of FIG. 8, and the same reference numerals are therefore used to denote corresponding integers.

In the embodiment shown in FIG. 11, the conveyor 38 carrying the flaps 71 is replaced by a fixed overhead lid 74 which carries a series of flaps 73, each of which is substantially identical to the flaps 71. Thus, in this case, the flaps do not travel through the tank with the poultry, but instead ride over the latter. Accordingly, the inboard edges of the flaps (which are pivotally attached to the lid 74) form the upstream edges of the flaps in relation to the direction of travel of the poultry through the apparatus. Again, the weight of the flaps on the poultry restrains the latter.

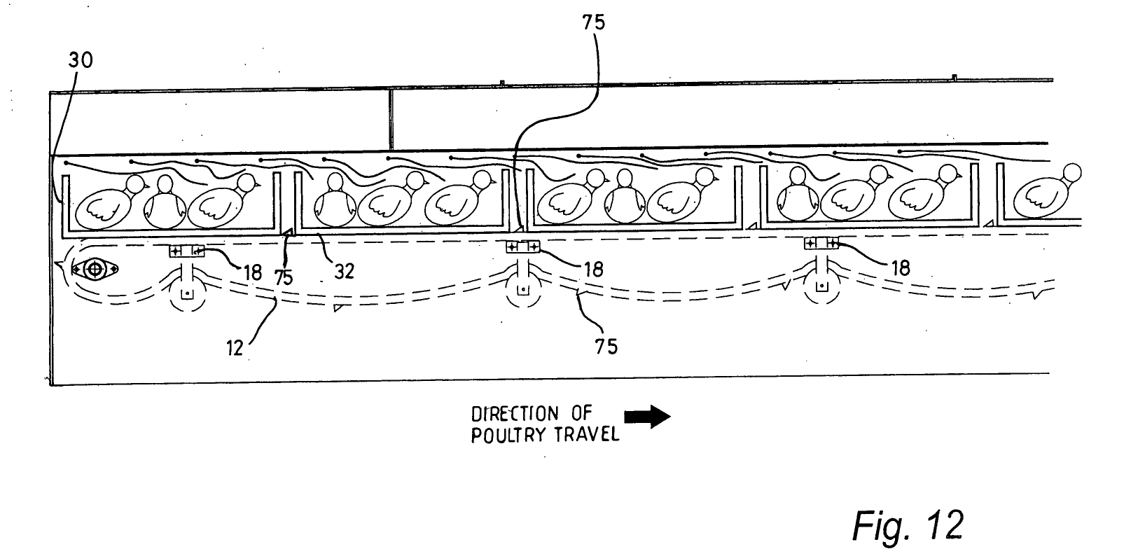

FIG. 12 shows a modification to the apparatus, namely the inclusion on the conveyor chain 12 of pusher links 75 which engage the trailing edges of the drawers to increase the force that can be applied on the drawers by the conveyor chains 10 and 12. The spacing between the pusher links 75 corresponds to the spacing between successive draws.

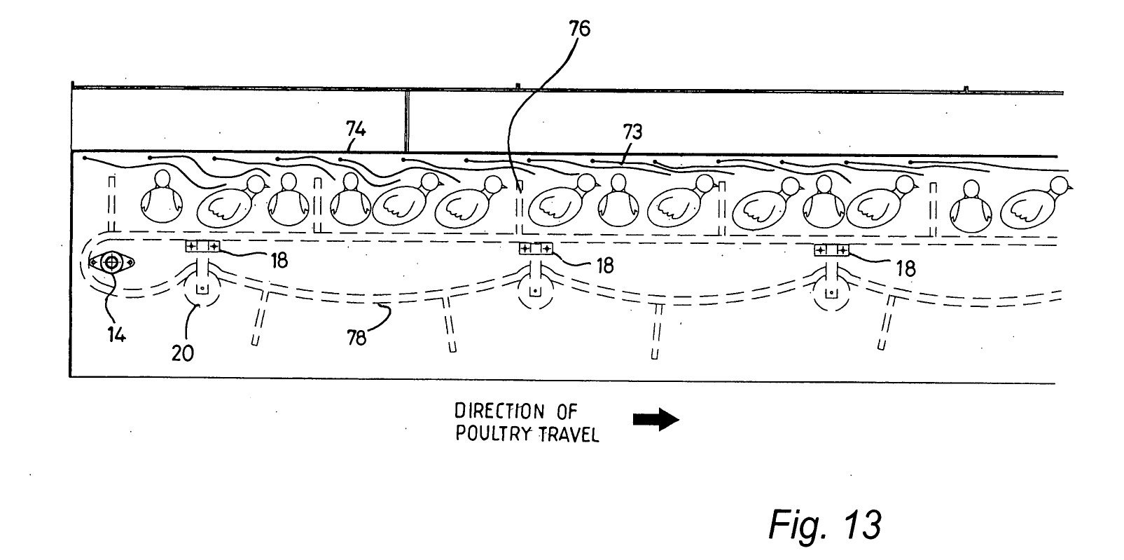

FIG. 13 shows a further modification to the apparatus of FIG. 11. In this case, the poultry is not conveyed through the apparatus on drawers but is instead placed on a belt 78 (which replaces the conveyor chains 10 and 12). Since the flaps 73 are fixed, the conveyor belt 78 carries a series of lateral walls, such as the wall 76 extending across less than the entire width of the belt in a direction perpendicular to the direction of movement of the belt. These walls are fixed at their bases to the conveyor belt 78 so that the tension in the upper portion of the belt 78 causes the walls 76 to project upwardly and to help to urge the poultry through the apparatus. The width of the walls 76, is less than the spacing between the pulley wheels of each axially aligned pair of pulley wheels 20. The walls 76 on the slack return of the belt can therefore pass between the pulley wheels since the wheels are located at the edge regions of the belt 78.

1. Poultry conveying apparatus for gas stunning apparatus for the gas stunning of poultry, the poultry conveying apparatus comprising a conveyor for transporting the poultry through a gas or gases in a chamber of the gas stunning apparatus, said gas or gases being effective to stun the poultry; and poultry restraining elements operable to engage poultry to prevent or inhibit movement of the poultry relative to the conveyor as the poultry is transported through at least part of the chamber, thereby to restrain the birds as they react to the gas or gases in the chamber.

2. Apparatus according to claim 1, in which the restraining elements constitute an array of elements which extends as far as an infeed opening through which poultry enters the chamber.

3. Apparatus according to claim 2, in which the elements comprise an array of flexible protuberances.

4. Apparatus according to claim 3, in which the protuberances, in use, extend into the path of the poultry through the chamber.

5. Apparatus according to claim 4, in which the protuberances comprise resilient fingers.

6. Apparatus according to claim 3, in which the protuberances comprise a series of flaps.

7. Apparatus according to claim 3, in which each protuberance comprises a resilient support member covered by a respective flexible cover.

8. Apparatus according to claim 7, in which the cover comprises a flap.

9. Apparatus according to claim 8, in which the resilient support members comprise plurality of resilient fingers.

10. Apparatus according to claim 1, in which the apparatus includes an engagement mechanism for bringing the elements into engagement with the poultry and separation mechanism for subsequently separating the elements from the poultry to allow the latter to be removed.

11. Apparatus according to claim 6, in which the flaps are mounted in a fixed relationship to the chamber so that the conveying means moves the poultry relative to the flaps.

12. Apparatus according to claim 11 in which the flaps are mounted above the conveying means, each flap being able to swing in the direction of conveyance of the poultry.

13. Apparatus according to claim 1, in which the restraining elements are mounted on a further conveyor for moving the elements along the path of the poultry through the chamber, said further conveyor also acting as the engagement and separation mechanisms.

14. Apparatus according to claim 13 in which the further conveyor is situated above said conveyor for conveying the poultry, so that the elements, in use, engage the poultry from above.

15. Apparatus according to claim 13 in which the conveyor and further conveyor include at least one drive mechanism operable to drive both of said conveyors at substantially the same speed.

16. Apparatus according to claim 13, in which the further conveyor includes a belt from which the restraining elements project into the path of the poultry.

17. Gas stunning apparatus for use in the gas stunning of poultry, the apparatus comprising a chamber for containing a gas or mixture of gases for stunning the poultry, conveying apparatus for conveying poultry through the chamber, a feed for supplying poultry to an infeed of the conveying apparatus and an outlet for the removal of poultry from the conveying apparatus, wherein the conveying apparatus comprises poultry conveying apparatus in accordance with claim 1.

18. A method of stunning poultry, the method comprising the steps of:
(a) exposing the poultry to a gaseous environment effective to stun the poultry;
(b) ensuring that, when so exposed, the poultry is restrained by the restraining elements which engage the poultry to prevent or inhibit movement of the latter thereby to reduce or prevent damage to the birds as they react to the gaseous environment;
(c) subsequently removing the poultry from the gaseous environment.

19. A method according to claim 18 in which the poultry is conveyed through said environment, and the restraining elements engage the poultry prior to the commencement of said exposing step, to ensure that the poultry enter the gaseous chamber and do not move relative to the conveyor.

20. A method according to claim 18, in which, while being exposed to said gaseous environment, the poultry are conveyed from an infeed to an outlet of a chamber containing said environment.

21. A method according to claim 20 in which the elements are also conveyed with the poultry.

22. A method according to claim 20, in which the conveying step is achieved by supporting the poultry on a first conveyor.

23. A method according to claim 22 in which the elements are carried by a second conveyor operating at substantially the same speed as the first conveying means.
